(19) United States
(12) Patent Application Publication
(10) Pub. No.: US 2020/0160025 A1
(43) Pub. Date: May 21, 2020

(54) Electronic Device

(71) Applicant: Huawei Technologies Co., Ltd., Shenzhen (CN)

(72) Inventor: Nicolas Dangy-Caye, Munich (DE)

(21) Appl. No.: 16/627,664

(22) PCT Filed: Jul. 6, 2017
(86) PCT No.: PCT/EP2017/066971

§ 371 Date: Dec. 30, 2019

(51) Int. Cl. G06K 9/00; G06F 21/32; G06F 3/041; G06F 3/044

(52) U.S. Cl. CPC G06K 9/00013; G06F 21/32; G06F 3/0446; G06K 9/00087; G06F 3/0416

(57) ABSTRACT

An electronic device with a touch sensitive surface includes a configuration for detecting, using a touch sensing arrangement, a finger touching the touch sensitive surface. The touch sensing arrangement is associated with a first area within the touch sensitive surface. Using a fingerprint recognition arrangement, a second area within the first area is scanned for fingerprint recognition of the finger, where the second area is determined based on a first output from the touch sensing arrangement. The fingerprint recognition arrangement includes readout circuitry covering the second area, where the second area is smaller than the first area. An illuminator from a plurality of illuminators is activated based on a second output from the touch sensing arrangement, wherein the illuminators correspond to the first area.

### CROSS-REFERENCE TO RELATED APPLICATIONS

This application is a U.S. National Stage of International Patent Application No. PCT/EP2017/066971 filed Jul. 6, 2017, which is hereby incorporated by reference in its entirety.

### TECHNICAL FIELD

The following disclosure generally relates to an electronic device, and more specifically to an electronic device that is equipped with fingerprint recognition function and touch sensing function.

### BACKGROUND

Fingerprint sensing and matching is a reliable and widely used technique for personal identification or verification in electronic devices such as a smart phone, tablet personal computer (PC), desktop PC, portable multimedia player (PMP), Moving Picture Experts Group phase 1 or phase 2 (MPEG-1 or MPEG-2) audio layer-3 (MP3) player, or wearable device.

In particular, a common approach to fingerprint identification involves scanning a sample fingerprint or an image thereof and storing the image and/or unique characteristics of the fingerprint image. The characteristics of a sample fingerprint may be compared to information for reference fingerprints already in a database to determine proper identification of a person, such as for verification purposes.

A fingerprint sensor may be particularly advantageous for verification and/or authentication in an electronic device, and more particularly, a portable device, for example. Such a fingerprint sensor may be carried by the housing of a portable electronic device, for example, and may be sized to sense a fingerprint from a single-finger.

Where a fingerprint sensor is integrated into an electronic device or host device, for example, as noted above, it may be desirable to more quickly perform authentication, particularly while performing another task or an application on the electronic device. In other words, in some instances it may be undesirable to have a user perform an authentication in a separate authentication step, for example switching between tasks to perform the authentication.

### SUMMARY

It is an object of the invention to provide an electronic device comprising touch sensitive surface.

The foregoing and other objects are achieved by the subject matter of the independent claims. Further implementation forms are apparent from the dependent claims, the description and the figures.

According to a first aspect, an electronic device is provided. The electronic device includes a touch sensitive surface, a touch sensing arrangement which associates with a first area within the touch sensitive surface, and a fingerprint recognition arrangement which associates with a second area within the first area. The fingerprint recognition arrangement includes a readout circuitry being designated, that is, covering, only to the second area, wherein the second area is smaller than the first area.

In this case, touching information (e.g. sub matrix/pixels) from only the second area will be directed to the readout circuitry for purpose of fingerprint recognition. Thus a scaled down readout circuitry is possible to be equipped to processing fingerprint recognition related to only the second area, i.e. touching area(s).

Optionally, the touch sensing arrangement may be any of the following: the touch sensor 203 in FIG. 2, the multi-touch sensor 903 in FIG. 9, the touch panel 1002 in FIG. 10; the first area may be any of the following: the “active area” 405 in FIG. 4, the “active area” 500 in FIG. 5, the “active area” 805 in FIG. 8a/8c; the fingerprint recognition arrangement may be any of the following: fingerprint recognition sensor 201 in FIG. 2, the fingerprint recognition processing mechanism of FIG. 7, the hi resolution touch sensor 905 in FIG. 9, the OPD 1004 in FIG. 10; the readout circuitry may be any of the following: the readout circuitry 703 in FIG. 7, the readout circuitry 1205 in FIG. 12a; the second area may be any of the following: location(s) of the cue 403 in FIG. 4, location(s) of detected finger touching 405 in FIG. 5, location of high resolution local scan 803 in FIG. 8a/8c.

Thanks to the dedicated readout circuitry, in-display fingerprint recognition solution may consume as less power as a conventional fixed single finger area approach, e.g. Huawei P9 with a rear-mounted fingerprint solution.

In a first possible implementation form of the electronic device according to the first aspect, the second area is determined based on an output from the touch sensing arrangement.

Depending on an output from the touch sensing arrangement, for example, which location(s) finger touching is detected, place to scan (e.g. where a finger is placed) for fingerprint recognition is dynamically determined. This may enrich UI design for various scenarios where fingerprint recognition is required. Optionally, with finger location given by a separate low resolution sensor (e.g. the touch sensing arrangement), fingerprint recognition performed by a separate high resolution sensor (e.g. the fingerprint recognition arrangement), significant power saving may be possible compared with a full-display fingerprint recognition solution in which high resolution is required for both finger location detection and fingerprint recognition.

In a second possible implementation form of the electronic device according to the first aspect as such or according to the first implementation form thereof, the fingerprint recognition arrangement comprises a scanning circuitry corresponding to the second area.

Due to limited area (i.e. the second area) within a display (e.g. the first area) needs to be scanned, a relatively tinier/scaled down scanning circuitry corresponding to the limited area may serve an in-display fingerprint recognition well.

In a third possible implementation form of the electronic device according to the first aspect as such or according to any one of the preceding implementation forms thereof, the electronic device further includes a plurality of illuminators corresponding to the first area. Optionally, at least one illuminator from the plurality of illuminators is activated based on output from the touch sensing arrangement, and the at least one illuminator is located at or close to the second area.

Such illuminators may contribute to better fingerprint recognition, e.g. dynamic illumination around finger location(s) while scanning. They may also enrich UI design for various scenarios where fingerprint recognition is required.

According to a second aspect of the invention, a method is provided for processing fingerprint recognition for an electronic device with a touch sensitive surface. The method includes: detecting, by a touch sensing arrangement, at least one finger touching the touch sensitive surface, the touch sensing arrangement being associated with a first area within the touch sensitive surface; and in response, scanning, by a fingerprint recognition arrangement, only a second area within the first area for fingerprint recognition of the detected finger, wherein the fingerprint recognition arrangement comprises a readout circuitry being designated only to the second area, and the second area is smaller than the first area.

In this case, touching information (e.g. sub matrix/pixels) from only the second area will be directed to the readout circuitry for purpose of fingerprint recognition. Thus a scaled down readout circuitry is possible to be equipped to processing fingerprint recognition related to only the second area, i.e. touching area(s).

According to a third aspect of the invention, a method is provided for operating the electronic device aforementioned.

According to a fourth aspect of the invention, an electronic device is provided to include corresponding means for carrying out the method(s) aforementioned.

According to a fifth aspect of the invention, an apparatus is provided. The apparatus includes: at least one processor; and at least one memory, the at least one memory comprising instructions that when executed by the at least one processor, cause the apparatus to perform any of the aforementioned method.

According to a sixth aspect of the invention, a computer program product is provided. The computer program product is adapted to perform the method(s) aforementioned.

According to a seventh aspect of the invention, a computer program comprising software code is provided. The computer program is adapted to perform the method(s) aforementioned.

According to an eighth aspect of the invention, a computer readable storage medium comprising the computer program aforementioned is provided.

According to a ninth aspect of the invention, a computer readable storage medium comprising instructions to cause an electronic device aforementioned to carry out method(s) aforementioned is provided.

### BRIEF DESCRIPTION OF THE DRAWINGS

Further embodiments of the invention will be described with respect to the following figures, in which:

FIG. 1 is a block diagram illustrating a configuration of an electronic device in a network environment according to an embodiment of the present disclosure;

FIG. 2 is a block diagram illustrating a configuration of an electronic device according to an embodiment of the present disclosure;

FIG. 3 is a block diagram illustrating a configuration of a program module according to an embodiment of the present disclosure;

FIG. 4 depicts an electronic device according to an embodiment of the present disclosure;

FIG. 5a-5c are various top views of an electronic device showing options for operating a full panel fingerprint sensor in a display;

FIGS. 6a-6d are various top views of an electronic device showing scenarios for operating an in-display fingerprint recognition;

FIG. 7 illustrates a fingerprint recognition processing mechanism according to an embodiment of the present disclosure;

FIG. 8a-8c illustrate various in-display fingerprint recognition mechanism according to embodiments of the present disclosure;

FIG. 9 illustrates an in-display fingerprint recognition enabled electronic device according to an embodiment of the present disclosure;

FIG. 10 illustrates an in-display fingerprint recognition enabled electronic device according to an embodiment of the present disclosure;

FIGS. 11a-11d illustrate an in-display fingerprint recognition enabled electronic device according to embodiments of the present disclosure;

FIGS. 12a-12d illustrate an in-display fingerprint recognition enabled electronic device according to embodiments of the present disclosure;

FIGS. 13a-13d illustrate sub-matrix extraction to a readout circuitry according to embodiments of the present disclosure;

FIG. 14 illustrates a summarized state machine model according to embodiments of the present disclosure.

In the figures, identical reference signs are used for identical or at least functionally equivalent features.

### DETAILED DESCRIPTION OF THE EMBODIMENTS

In the following detailed description, reference is made to the accompanying drawings, which form a part of the disclosure, and in which are shown, by way of illustration, specific aspects in which the present invention may be practiced. It is understood that other aspects may be utilized and structural or logical changes may be made without departing from the scope of the present invention. The following detailed description, therefore, is not to be taken in a limiting sense, as the scope of the present invention is defined by the appended claims.

For instance, it is understood that a disclosure in connection with a described method may also hold true for a corresponding device or system configured to perform the method and vice versa. For example, if a specific method step is described, a corresponding device may include a unit/module to perform the described method step or corresponding function, even if such unit/module is not explicitly described or illustrated in the figures, and vice versa. Further, a person skilled in the art would appreciate that the features of the various exemplary aspects described herein may be combined with each other, unless specifically noted otherwise.

Furthermore, in the present disclosure, the expression “and/or” includes any and all combinations of the associated listed words. For example, the expression “A and/or B” may include A, may include B, or may include both A and B.

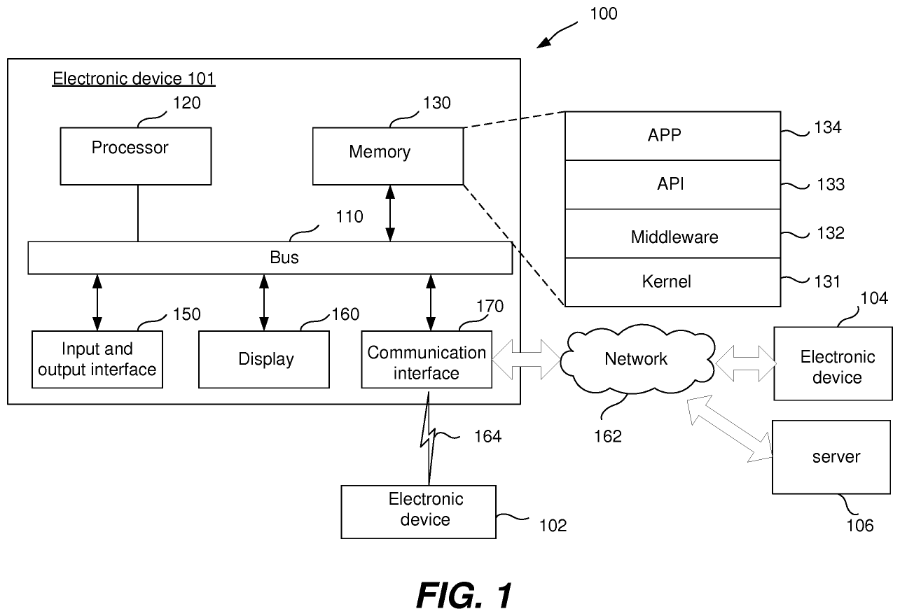

FIG. 1 is a block diagram illustrating a configuration of an electronic device according to an embodiment of the present disclosure.

Referring to FIG. 1, a network environment 100 may include the electronic device 101, other electronic devices 102 and 104, and/or a server 106. The electronic device 101 may include a bus 110, a processor 120, a memory 130, a user input and output interface/module 150, a display module 160, a communication interface/module 170 and other similar and/or suitable components.

The bus 110 may be a circuit which interconnects the above-described elements and facilitates a communication (e.g., delivering control messages) between the above-described elements. The processor 120 may receive commands from the above-described other elements (e.g., the memory 130, the user input and output interface/module 150, the display module 160, the communication interface/module 170, etc.) through the bus 110, may interpret the received commands, and may execute calculation or data processing according to the interpreted commands. The memory 130 may store commands or data received from the processor 120 or other elements (e.g., the user input and output interface/module 150, the display module 160, the communication interface/module 170, etc.), or generated by the processor 120 or the other elements.

The memory 130 may include programming modules, such as a kernel 131, a middleware 132, an application programming interface (API) 133, at least one application 134, and the like. Each of the above-described programming modules may be implemented in software, firmware, hardware, or a combination of two or more thereof.

The kernel 131 may control or manage system resources (e.g., the bus 110, the processor 120, the memory 130, etc.) used to execute operations or functions implemented by other programming modules (e.g., the middleware 132, the API 133, and the application 134). In addition, the kernel 131 may provide an interface capable of accessing and controlling or managing the individual elements of the electronic device 101 by using the middleware 132, the API 133, or the application 134.

The middleware 132 may serve to go between the API 133 or the application 134 and the kernel 131 in such a manner that the API 133 or the application 134 communicates with the kernel 131 and exchanges data therewith. For example, the middleware 132 may be configured to be an intermediary for communication between the API 133 or the application 134 and the kernel 131. In addition, in relation to work requests received from one or more applications 134, the middleware 132, for example, may perform load balancing of the work requests by using a method of assigning a priority, in which system resources (e.g. the bus 110, the processor 120, the memory 130, etc.) of the electronic device 101 can be used, to at least one of the one or more applications 134.

The API 133 is an interface through which the application 134 is capable of controlling a function provided by the kernel 131 or the middleware 132, and may include, for example, at least one interface or function for file control, window control, image processing, character control, and/or the like.

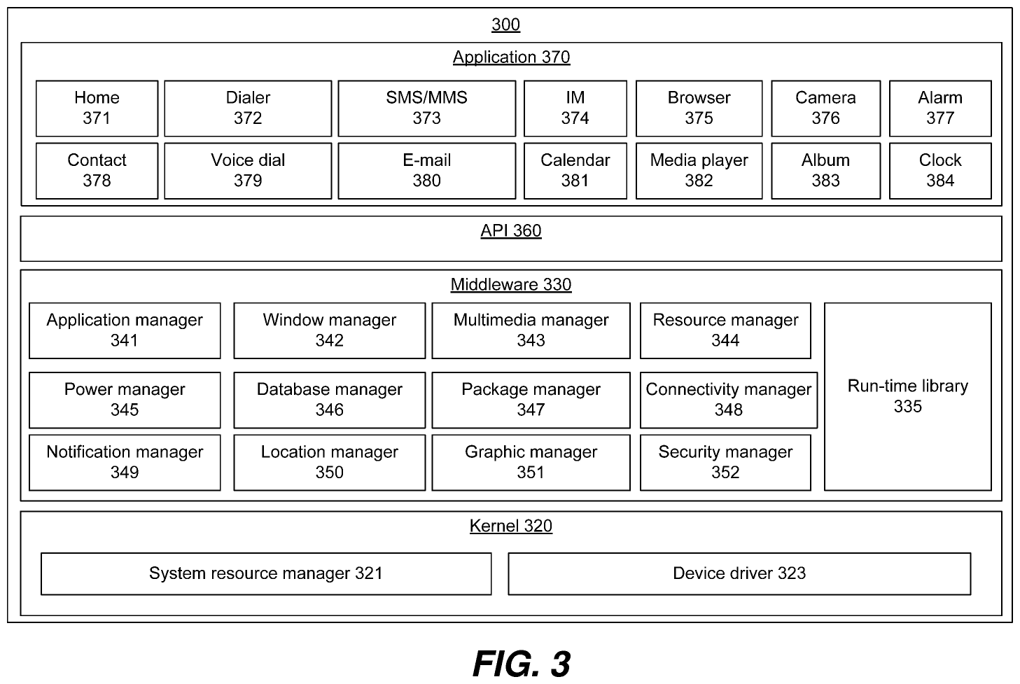

The applications 134 may include, for example, a home application, a dialer application, a short message service (SMS)/multimedia message service (MMS) application, an instant message (IM) application, a browser application, a camera application, an alarm application, a contact application, a voice dial application, an electronic mail (e-mail) application, a calendar application, a media player application, an album application, a clock application, and any other suitable and/or similar application. Refer to FIG. 3 for more details.

The user input and output interface/module 150 may receive a command or data as input from a user via input-output means (e.g., sensor, keyboard, touchscreen, and/or the like) and may deliver the received command or data to the processor 120 or the memory 130 through the bus 110. The display module 160 may display a video, an image, data, and/or the like to the user. The display module 160 may display the received various information (e.g., multi-media data, text data) from the above-described elements.

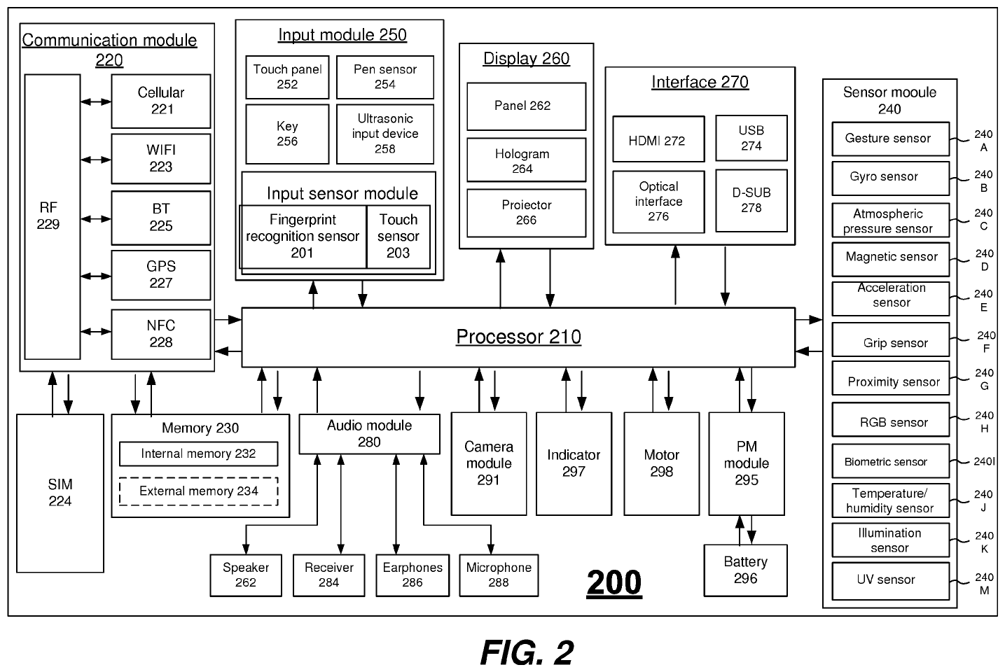

The communication interface/module 170 may control a short-range communication connection with another electronic device 102. When the electronic device 101 is paired with another electronic device, the communication interface 170 may stop a scan operation of waiting for reception of a signal from a neighboring electronic device or a broadcasting operation of broadcasting a signal. For example, in response to the electronic device 101 being paired with another electronic device 102, the communication interface 170 stop a scan operation of waiting for reception of a signal from a neighboring electronic device or a broadcasting operation of broadcasting a signal. When the electronic device 101 is paired with another electronic device, the communication interface 170 may control a cycle of the scan or broadcasting operation. Additional information on the communication configuration control module 170 is described below with respect to FIG. 2.

According to various embodiments of the present disclosure, the electronic device 101 may communicate with another electronic device using the communication interface 170. For example, the communication interface 170 may communicate with another electronic device 104, a server 106, and/or the like. The communication interface/module 170 may communicate with the other electronic device 104, the server 106, and/or the like directly or through a network 162. For example, the communication interface/module 170 may operate to connect the electronic device 101 to the network 162.

FIG. 2 is a block diagram illustrating a configuration of an electronic device according to an embodiment of the present disclosure.

Referring to FIG. 2, the electronic device 200 may be, for example, the electronic device 101 illustrated in FIG. 1. As illustrated in FIG. 2, hardware of the electronic device 200 may include one or more application processors (APs) 210, a subscriber identification module (SIM) card 224, a communication module 220, a memory 230, a sensor module 240, an input module 250, a display module 260, an interface 270, an audio module (e.g., audio coder/decoder (codec)) 280, a camera module 291, a power management module 295, a battery 296, an indicator 297, a motor 298 and any other similar and/or suitable components.

The AP 210 (e.g., the processor) may include one or more APs, or one or more communication processors (CPs). The AP 210 may execute an operating system (OS) or an application program, and thereby may control multiple hardware or software elements connected to the AP 210 and may perform processing and arithmetic operations on various data including multimedia data. The AP 210 may be implemented by a system on chip (SoC). According to various embodiments of the present disclosure, the AP 210 may further include a graphics processing unit (GPU) (not illustrated).

The SIM card 224 may be a card implementing a subscriber identification module, and may be inserted into a slot formed in a particular portion of the electronic device 101. The SIM card 224 may include unique identification information (e.g., integrated circuit card identifier (ICCID)) or subscriber information (e.g., international mobile subscriber identity (IMSI)).

The communication module 220 may be the communication interface 170 illustrated in FIG. 1. The communication module 220 may include a radio frequency (RF) module 229. The communication module 220 may further include a cellular module 221, a Wi-Fi module 223, a Bluetooth (BT) module 225, a GPS module 227, and a near field communication (NFC) module 228. The communication module 220 may provide a wireless communication function by using a radio frequency. Additionally or alternatively, the communication module 220 may include a network interface (e.g., a local area network (LAN) card), a modulator/demodulator (modem), and the like for connecting the electronic device 200 to a network (e.g., the Internet, a LAN, a wide area network (WAN), a telecommunication network, a cellular network, a satellite network, a plain old telephone service (POTS), and/or the like).

The cellular module 221 may further include a CP. The CP may control the transmission and reception of data by the communication module 220. As illustrated in FIG. 2, the elements such as the CP, the power management module 295, the memory 230, and the like are illustrated as elements separate from the AP 210. However, according to various embodiments of the present disclosure, the AP 210 may include at least some (e.g., the CP) of the above-described elements. The CP may manage a data line and may convert a communication protocol in the case of communication between the electronic device 200 (e.g., the electronic device 101) and different electronic devices connected to the electronic device through the network.

The RF module 229 may be used for transmission and reception of data, for example, transmission and reception of RF signals or called electronic signals. Although not illustrated, the RF unit 229 may include a transceiver, a power amplifier module (PAM), a frequency filter, a low noise amplifier (LNA), and/or the like. In addition, the RF module 229 may further include a component for transmitting and receiving electromagnetic waves in a free space in a wireless communication, for example, a conductor, a conductive wire, or the like.

The memory 230 may include an internal memory 232. An external memory 234 may be included as well. The memory 230 may be, for example, the memory 130 illustrated in FIG. 1. According to various embodiments of the present disclosure, internal memory 232 may include, for example, at least one of a volatile memory (e.g., a dynamic random access memory (DRAM), a static RAM (SRAM), a synchronous dynamic RAM (SDRAM), and/or the like), and a non-volatile memory (e.g., a one-time programmable read-only memory (OTPROM), a programmable ROM (PROM), an erasable and programmable ROM (EPROM), an electrically erasable and programmable ROM (EEPROM), a mask ROM, a flash ROM, a not AND (NAND) flash memory, a not OR (NOR) flash memory, and/or the like). According to various embodiments of the present disclosure, the internal memory 232 may be in the form of a solid state drive (SSD). The external memory 234 may further include a flash drive, such as a compact flash (CF), a secure digital (SD), a micro-SD, a mini-SD, an extreme digital (xD), a memory stick, and/or the like.

The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a red, green and blue (RGB) sensor 240H, a biometric sensor 240I, a temperature/humidity sensor 240J, an illumination sensor 240K, and an ultra violet (UV) sensor 240M. The sensor module 240 may measure a physical quantity and/or may detect an operating state of the electronic device 101, and may convert the measured or detected information to an electrical signal. The sensor module 240 may also include an E-nose sensor (not illustrated), an electromyography (EMG) sensor (not illustrated), an electroencephalogram (EEG) sensor (not illustrated), an electrocardiogram (ECG) sensor (not illustrated), a fingerprint sensor (not illustrated), and/or the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and/or the like. The sensor module 240 may further include a control circuit (not illustrated) for controlling one or more sensors included therein.

The input device 250 may include at least one of a touch panel 252, (digital) pen sensor 254, key 256, ultrasonic input device 258, or input sensing module 259. The touch panel 252 may use at least one method of a capacitive, resistive, infrared ray method, or ultrasonic wave method. The touch panel 252 may further include a control circuit. The touch panel 252 may further include a tactile layer to provide a tactile sense reaction to a user. The (digital) pen sensor 254 may include, for example, a portion of the touch panel 252 or a separate recognition sheet. The key 256 may include a physical button, optical key, or keypad. The ultrasonic input device 258 may detect an ultrasonic wave that has occurred in an input instrument through a microphone (e.g., a microphone 288) and determine data corresponding to the detected ultrasonic wave. The input sensing module 259 may include at least one fingerprint recognition sensor 201 and at least one touch sensor 203. The input sensing module 259 may include the fingerprint recognition sensor 201 and the touch sensor 203 that detect an input with the same sensing method. For example, both the fingerprint recognition sensor 201 and the touch sensor 203 of the input sensing module 259 may detect an input with a capacitive method. The input sensing module 259 may include an input processor electrically connected to the fingerprint recognition sensor 201 and the touch sensor 203 and that processes an input received from the fingerprint recognition sensor 201 or the touch sensor 203 and that transfers the processed input to the processor. The input sensing module 259 may include a flexible circuit board, and the touch sensor 203, the fingerprint recognition sensor 201, and the input processor of the input sensing module 259 may be electrically connected to the flexible circuit board. The input sensing module 259 may be disposed at a location corresponding to a lower end key (e.g., a home key or a soft key) of a front portion of the electronic device. For example, the input sensing module 259 may detect a user's fingerprint input or touch input received from a home key or a soft key through the touch sensor 203 or the fingerprint recognition sensor 201. The input sensing module 259 may detect a touch input received through a touch input area formed in a side surface portion of the electronic device using the touch sensor 203 and detect a fingerprint input received using a home key through the fingerprint recognition sensor 201. The input sensing module 259 may process a received input and transfer the processed input to the processor. The input processor and the fingerprint recognition sensor 201 may be formed in one chip form.

The display module 260 may include a panel 262, a hologram 264, a projector 266, and the like. The display module 260 may be, for example, the display module 160 illustrated in FIG. 1. The panel 262 may be a liquid crystal display (LCD) and an active matrix organic light emitting diode (AM-OLED) display, and the like. The panel 262 may be implemented so as to be flexible, transparent, or wearable. The panel 262 may include the touch panel 252 and one module. The hologram 264 may display a three-dimensional image in the air by using interference of light. According to various embodiments of the present disclosure, the display module 260 may further include a control circuit for controlling the panel 262 or the hologram 264.

The interface module 270 may include at least one of a high-definition multimedia interface (HDMI) module 272, a universal serial bus (USB) module 274, an optical interface module 276, a D-subminiature (D-SUB) module 278, and the like. Additionally or alternatively, the interface 270 may include, for example, one or more interfaces for SD/multimedia card (MMC) (not shown) or infrared data association (IrDA) (not shown). The interface module 270 or any of its sub-modules may be configured to interface with another electronic device (e.g., an external electronic device), an input device, an external storage device, and/or the like.

The audio module 280 may encode/decode voice into electrical signal, and vice versa. The audio module 280 may encode/decode voice information that are input into, or output from, a speaker 282, a receiver 284, an earphone 286, and/or a microphone 288.

The camera module 291 may capture still images or video. According to various embodiments of the present disclosure, the camera module 291 may include one or more image sensors (e.g., front sensor module or rear sensor module; not shown), an image signal processor (ISP, not shown), or a flash LED, not shown.

The power management module 295 may manage electrical power of the electronic device 200. Although not shown, the power management module 295 may include a power management IC (PMIC), a charger IC, a battery fuel gauge, and/or the like. The PMIC may be disposed in an IC or a SoC semiconductor. The charging method for the electronic device 200 may include wired or wireless charging. The charger IC may charge a battery, or prevent excessive voltage or excessive current from a charger from entering the electronic device 200. According to various embodiments of the present disclosure, the charger IC may include at least one of a wired charger IC or a wireless charger IC. The wireless charger IC may be a magnetic resonance type, a magnetic induction type or an electromagnetic wave type, and may include circuits such as, for example, a coil loop, a resonance circuit or a rectifier. The battery gauge may measure a charge level, a voltage while charging, a temperature of battery 296, and the like. The battery 296 may supply power to, for example, the electronic device 200. The battery 296 may be a rechargeable battery.

The indicator 297 may indicate one or more states (e.g., boot status, message status, or charge status) of the electronic device 200 or a portion thereof (e.g., the AP 211). The motor 298 may convert electrical signal into mechanical vibration.

Although not illustrated, the electronic device 200 may include a processing unit (e.g., a GPU) for supporting a module TV. The processing unit for supporting a module TV may process media data according to standards such as, for example, digital multimedia broadcasting (DMB), digital video broadcasting (DVB), media flow, and/or the like.

According to various embodiments of the present disclosure, each of the above-described elements of the electronic device 200 may include one or more components, and the name of the relevant element may change depending on the type of electronic device. According to various embodiments of the present disclosure, the electronic device 200 may include at least one of the above-described elements. Some of the above-described elements may be omitted from the electronic device 200, or the electronic device 200 may further include additional elements. In addition, according to various embodiments of the present disclosure, some of the elements of the electronic device 200 may be combined into one entity, which may perform functions identical to those of the relevant elements before the combination.

FIG. 3 is a block diagram illustrating a configuration of a programming module according to an embodiment of the present disclosure.

Referring to FIG. 3, the programming module 300 may be included (or stored) in the electronic device 101 (e.g., the memory 130) or may be included (or stored) in the electronic device 200 (e.g., the memory 230) illustrated in FIG. 1. At least a part of the programming module 300 may be implemented in software, firmware, hardware, or a combination of two or more thereof. The programming module 300 may be implemented in hardware (e.g., the electronic device 200), and may include an OS controlling resources related to an electronic device (e.g., the electronic device 101) and/or various applications (e.g., an application 370) executed in the OS. For example, the OS may be Android, iOS, Windows and the like.

Referring to FIG. 3, the programming module 300 may include a kernel 320, a middleware 330, an API 360, and/or the application 370.

The kernel 320 (e.g., the kernel 131) may include a system resource manager 321 and/or a device driver 323. The system resource manager 321 may include a processor manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 323 may include an inter-process communication (IPC) driver (not illustrated).

The middleware 330 may include multiple modules previously implemented so as to provide a function used in common by the applications 370. The middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage graphical user interface (GUI) resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and BT. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a UI related to the graphic effect. The security manager 352 may provide various security functions used for system security, user authentication, and the like. According to an embodiment of the present disclosure, when the electronic device (e.g. the electronic device 101) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. The middleware 330 may also dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In the case of Android or iOS, for example, one API set may be provided to each platform.

The applications 370 (e.g., the applications 134) may include, for example, a preloaded application and/or a third party application. The applications 370 (e.g. the applications 134) may include, for example, a home application 371, a dialer application 372, an SMS/MMS application 373, an IM application 374, a browser application 375, a camera application 376, an alarm application 377, a contact application 378, a voice dial application 379, an e-mail application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 230. At least a part of the programming module 300 may be implemented (e.g., executed) by, for example, the one or more processors 210. At least a part of the programming module 300 may include a module, a program, a routine, a set of instructions, and/or a process for performing one or more functions.

Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. Also, some of the operations may be omitted, or other operations may be added to the operations.

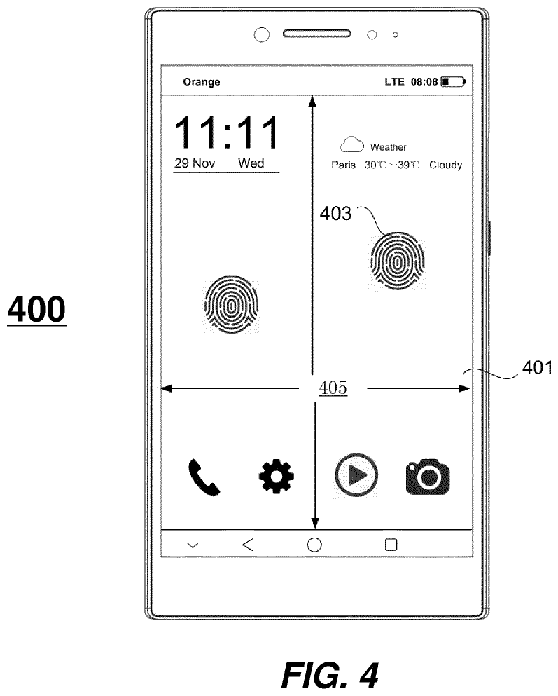

FIG. 4 depicts an electronic device according to an embodiment of the present disclosure.

Referring to FIG. 4, the electronic device 400 (e.g. the electronic device 101, the electronic device 200) may have a touch screen area 401 (e.g. the display 160, the touch panel 252, the touch sensor 203, the display 260), in a front portion. The fingerprint recognition sensor 201 may correspond to one or more areas of the touch screen area 401, and the touch sensor 203 may correspond to the whole area of the touch screen. The electronic device 400 may detect a user fingerprint at location(s) as indicated by visible cue 403 displayed on the screen. The cue 403 may be invisible if not needed, and become visible if needed. Location(s) of the cue 403 may be fixed on the touch screen, or may be dynamically determined. The electronic device 400 may receive a user's fingerprint input and/or touch input via the touch screen and provide a function corresponding to the received fingerprint input and/or touch input. The fingerprint sensing function may occur at any location on the display. The portion of the electronic device that functions to both display information and sense touch is the “active area” 405. FIG. 4 may be called in-display fingerprint recognition. Fingerprint recognition or fingerprint authentication refers to the automated method of verifying a match between two human fingerprints. Fingerprints are one of many forms of biometrics used to identify individuals and verify their identity. A Wikipedia entry for fingerprint recognition is available at: https://en.wikipedia.org/wiki/Fingerprint_recognition, last visited Mar. 16, 2017.

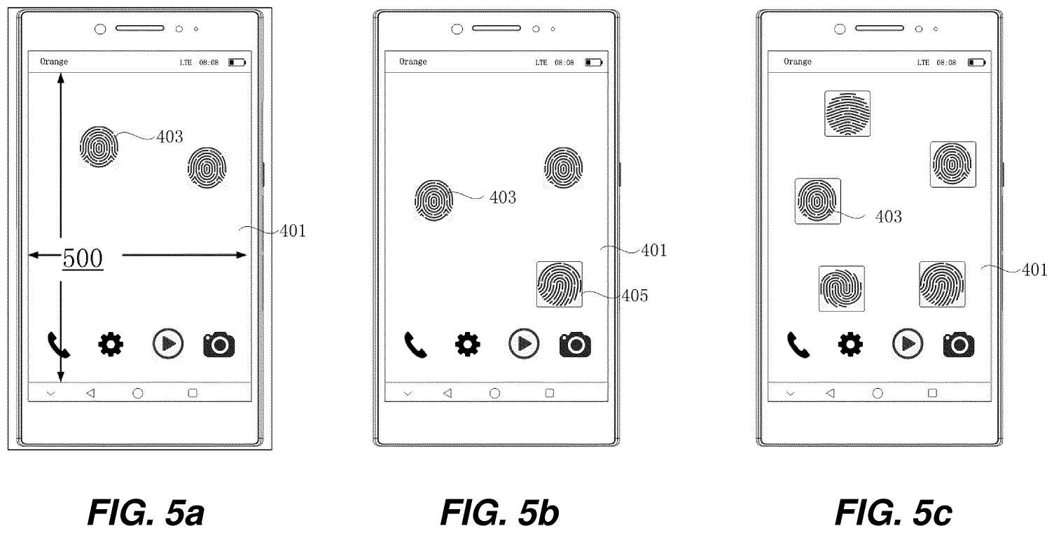

FIGS. 5a-5c are various top views of an electronic device showing options for operating a full panel fingerprint sensor in a display according to embodiments of the present disclosure. In FIGS. 5a-5c, the fingerprint sensing function may occur at any location on the display. In FIGS. 5a-5c, the portion of the electronic device that functions to both display information and sense touch is the “active area” 500 (e.g. active area 405 in FIG. 4). It should be appreciated that the active area 500 may change in size, shape and other configurations in various embodiments. In FIG. 5a, the display is configured as a single touch display and the full panel fingerprint sensor captures only one fingerprint 405 at a time. In FIG. 5b, the display is configured as a multi-touch display and the full panel fingerprint sensor captures only one fingerprint at a time. In FIG. 5c, the display is configured as a multi-touch display and the full panel fingerprint sensor captures multiple fingerprints substantially at one time. Offering a full panel fingerprint recognition brings several advantages that enrich user experience: it allows a freedom of placement within the panel; it may allow a multi-finger scanning; it can enhance the user interface (UI) and user eXperience (Ux) thanks to the finger type detection (e.g., thumb, grooming, middle, ring, little/left hand/right hand).

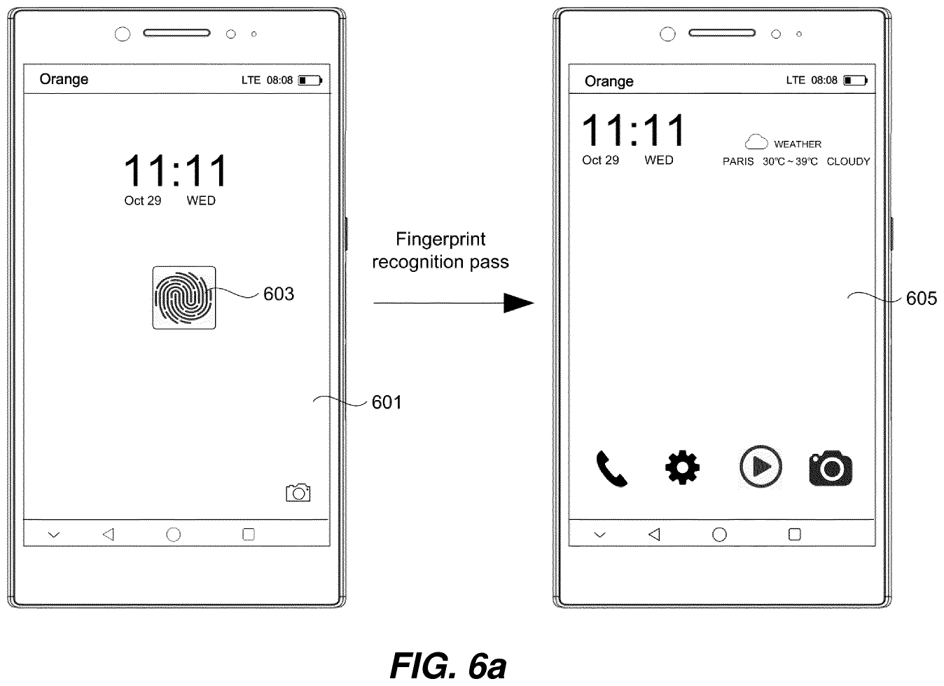

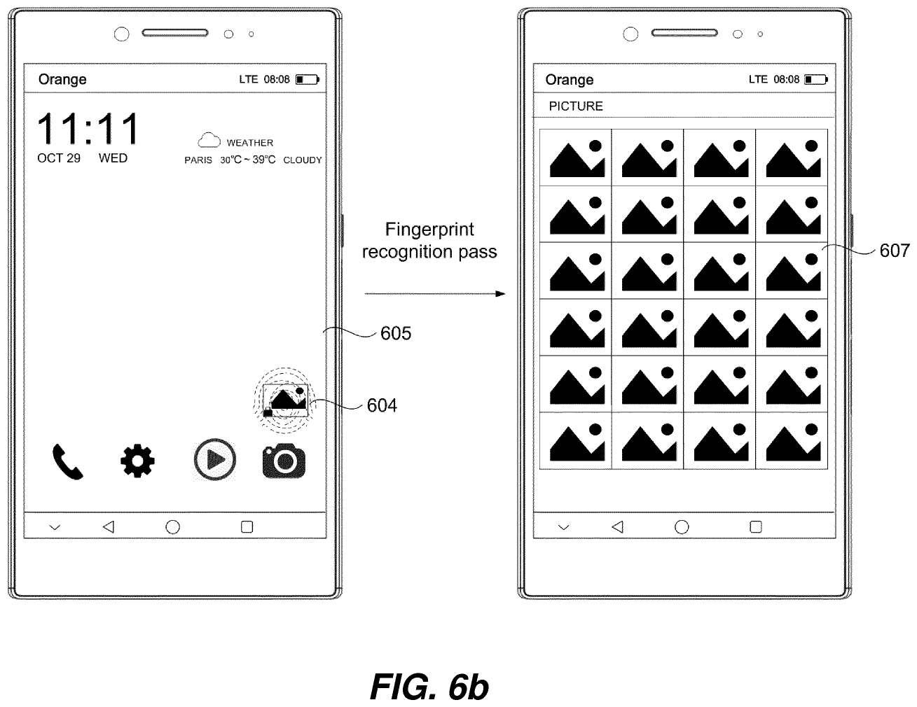

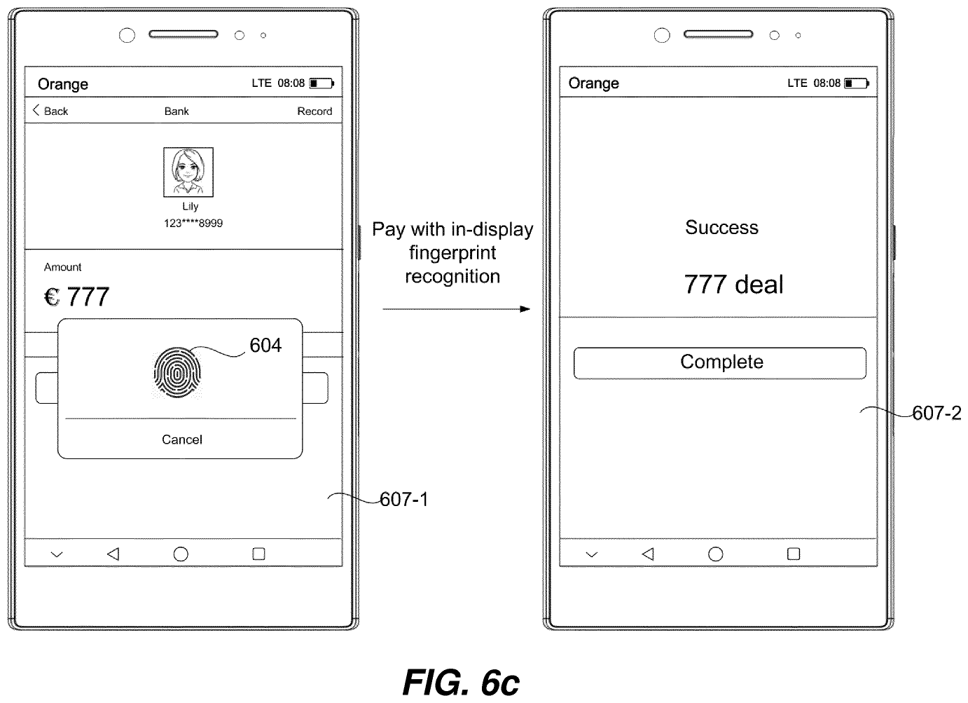

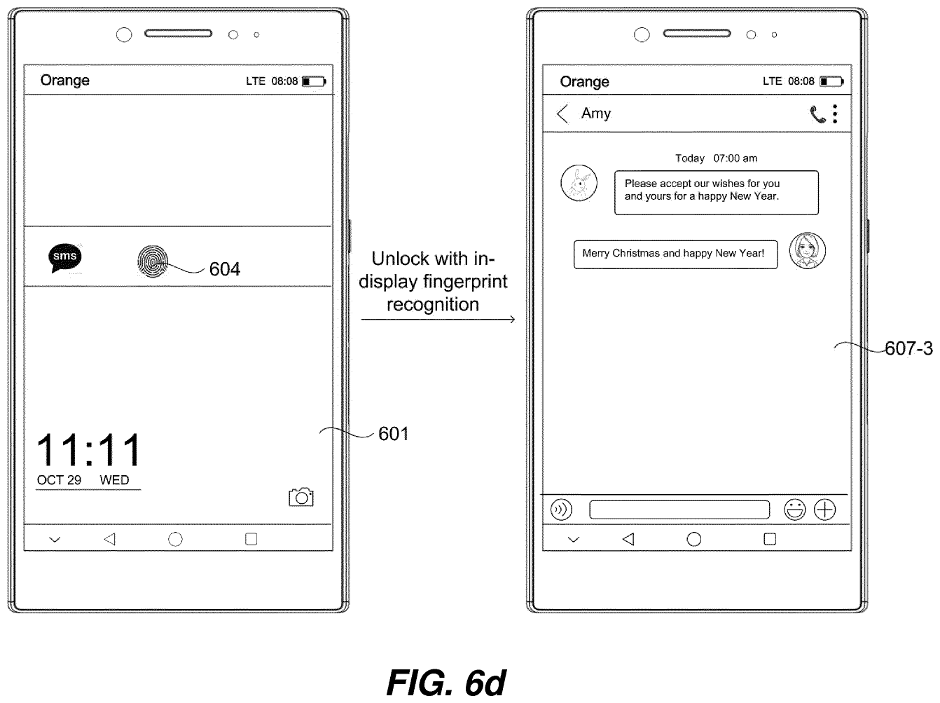

FIGS. 6a-6d are various top views of an electronic device showing scenarios for operating an in-display fingerprint recognition according to embodiments of the present disclosure. Similar to FIGS. 5a-5c, the fingerprint sensing function may occur at any location on the display, and the portion of the electronic device that functions to both display information and sense touch is the “active area” (e.g. similar to FIG. 4, FIGS. 5a-5c).

In FIG. 6a, the display is configured to show a lock screen UI 601 with a visible cue 603 in the active area to indicate fingerprint recognition in display. Once fingerprint recognition pass, the display is configure to show a main screen UI 605.

In FIG. 6b, the display is configured to show a main screen UI 605 with a plurality of APP icons (e.g. camera, call, video, setting, and picture). One or more APP may be locked and may need unlock means to open it. Visible cue 604 may be shown to indicate fingerprint recognition in display is needed. Once fingerprint recognition pass, the display is configured to show an in-APP screen UI 607. A person skilled in the art would appreciate that similar mechanism applies in-APP operations as well. For example, a specific operation may proceed with user touching a button in an APP and fingerprint recognition pass. In a case that the fingerprint recognition failed, the specific operation may not proceed even when the user touch the button to proceed.

In FIG. 6c, the display is configured to show an in-APP screen UI 607-1 with a visible cue 604 to indicate fingerprint recognition in display is needed to proceed (e.g. a financial transaction). Once fingerprint recognition pass, the display is configured to show another in-APP screen UI 607-2 (e.g. indication of a successful deal).

In FIG. 6d, the display is configured to show a lock screen UI 601 with a notification indicated (e.g. a new SMS is received). A visible cue 603 may be shown to indicate fingerprint recognition in display is needed. Once fingerprint recognition pass, the display is configured to shown an in-APP screen UI 607-3 to ensure that the notified SMS can be directly open from lock screen.

Fingerprint recognition in consumer electronic devices uses a wide range of technologies such as capacitive sensing, ultrasound or optical sensing. These technologies works in the in-display touch and/or full panel touch scenarios as well. Patent Application US2015/0036065 A1 describes a fingerprint sensor that can employ any type of sensing technology including capacitive, piezoelectric and ultrasonic sensing technology. Patent Application US2015/0331508 A1 describes an integrated display and touch sensor panel that can perform fingerprint recognition and uses image sensing technology through photodiode and illuminators. Patent Application US2015/0109214 A1 also describes a touch-fingerprinting display that can use capacitive or image sensing technology. All references are herein incorporated with their entireties.

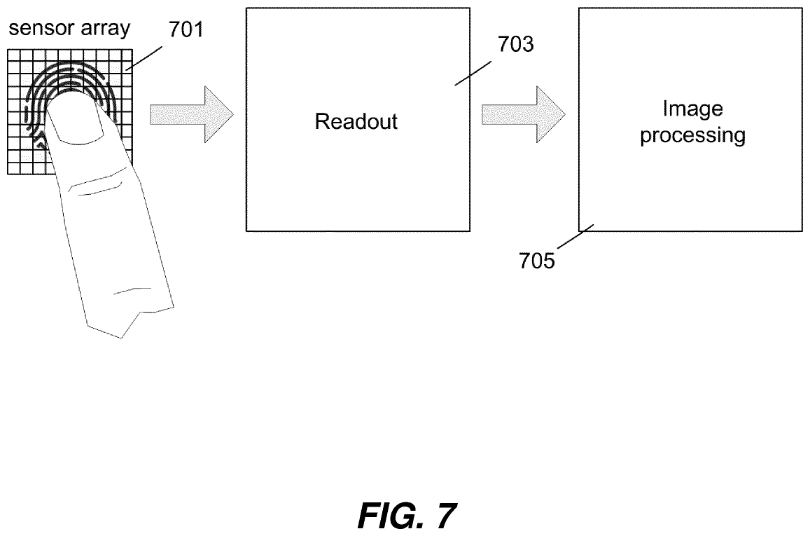

FIG. 7 illustrates a fingerprint recognition processing mechanism (i.e. a fingerprint recognition arrangement). The mechanism comprises a sensor array 701, a readout circuitry 703, and an image processing circuitry 705.

The readout circuitry may read out the sensed capacity of small values. A column-wise readout scheme may be generally used. It can consist of switches followed by an amplifier stage. The architecture in image sensing approach is very similar. The image sensor architecture consists of an array of pixels that are typically selected a row at a time by row select logic. The pixels are readout to vertical column busses that connect the selected row of pixels to a bank of analog signal processors (ASP's). These ASP's perform functions such as charge iteration, gain, sample & hold, correlated-double-sampling, and FPN suppression. These examples of capacitive or image sensing approaches show that the readout circuitry density is linked to the size of the sensor array 701. The larger the array, the more the cost of the readout circuitry. The larger the array, the more the power consumption of the system. An example of an architecture and implementation of a readout circuitry in a capacitive sensor is referred to: Tiao, Yu-Sheng, et al. “A CMOS readout circuit for LTPS-TFT capacitive fingerprint sensor.” Electron Devices and Solid-State Circuits, 2005 IEEE Conference on. IEEE, 2005. DOI: 10.1109/EDSSC.2005.1635353. This paper is herein incorporated with its entirety.

After an image of fingerprint is acquired via the sensor array 701 and the readout circuitry 703, image processing is needed to perform the fingerprint recognition. The image processing circuitry 705 may include any necessary processing algorithms, associated memory, and database needed. An example of image processing circuitry is referred to: Fossum, Eric R. “CMOS image sensors: Electronic camera-on-a-chip.” IEEE transactions on electron devices 44.10 (1997): 1689-1698. DOI: 10.1109/16.628824. This paper is herein incorporated with its entirety.

The inventor of this disclosure finds that conventional in-display/full panel fingerprint recognition solutions can be improved. Fingerprint recognition requires a much higher resolution for the sensor array (e.g. 701) than a conventional touch sensor. As an example, for the control frontier requirement, a 500 ppi resolution is needed. This means that the pixel density can be higher than conventional smartphone display when high level of recognition is needed. 500 ppi density would represent a pixel array of 2168×1211 for a 5″ display size. In other words, the requirement on resolution can be very demanding. This means that the readout part (e.g. 703) and the image processing part (e.g. 705) need to be scaled up as well. This implies an increase of the cost as the surface of display grows. Furthermore, power consumption would increase as the surface of display grows due to the sensor array (e.g. 701) powering and the enlarged readout circuitry (e.g. 703). As the resulted scanned image scales up, the image processing (e.g. 705) grows as well which impacts both cost and power consumption. Last but not least, the delay to process a full scan and identifying one or multiple fingers may be higher than a fixed single finger area. This delay may trouble and impact negatively user experience. In summary, implementing in-display/full panel fingerprint recognition needs to consider one or more of the following aspects: cost, power consumption, and processing delay.

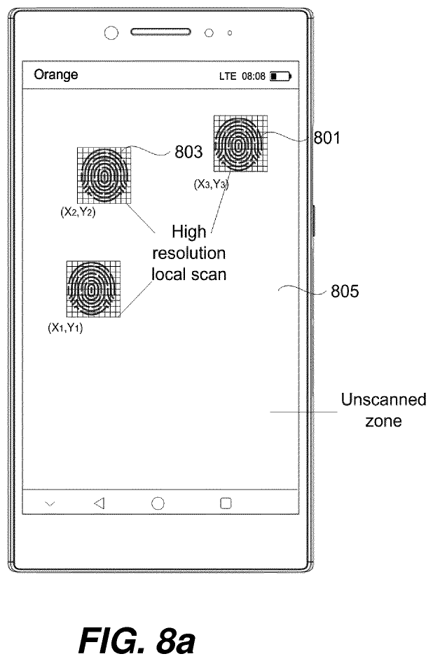

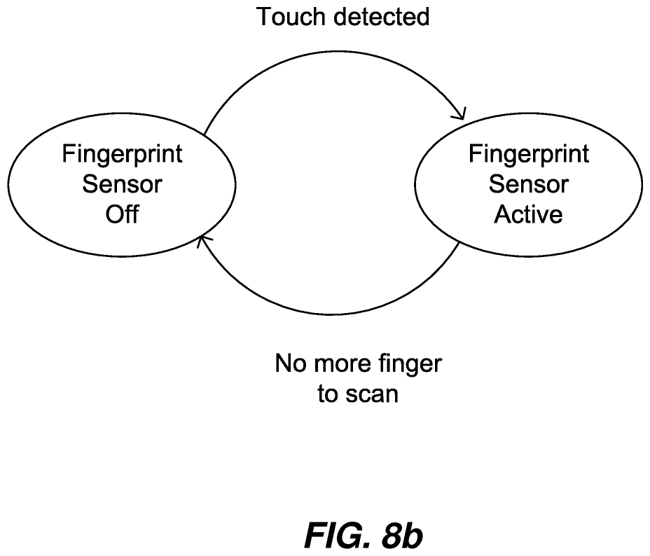

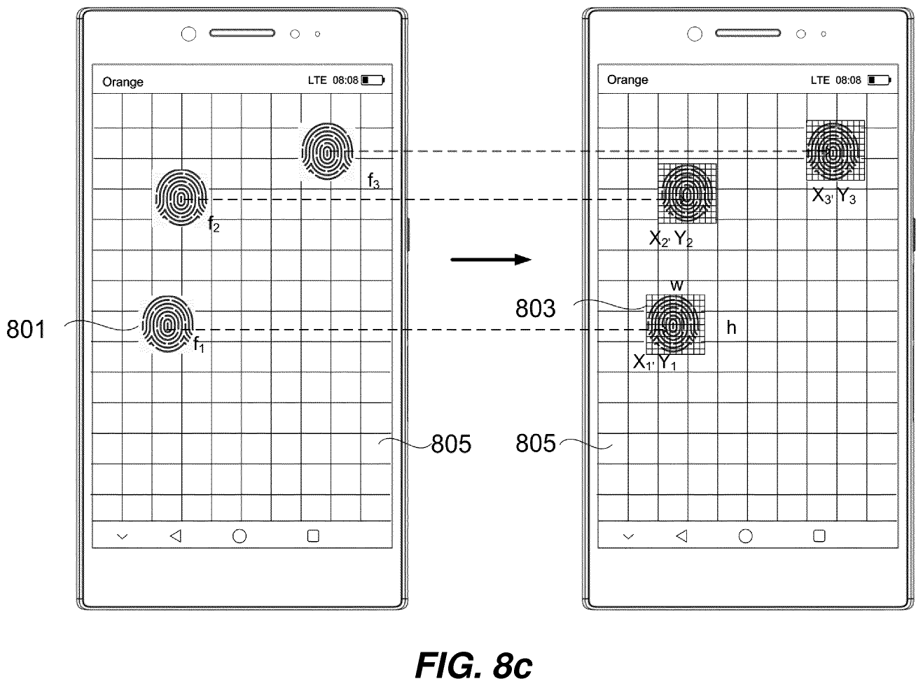

FIG. 8a-8c illustrates various in-display fingerprint recognition mechanism according to embodiments of the present disclosure.

In FIG. 8a, high resolution image 803 around finger(s) 801 is identified. As in conventional art, this operation is similar to the scenario that a small finger is put on the panel of a scan machine to do a long full scan; and the scan machine output a big sheet of paper with a tiny finger somewhere on the paper. Compared with conventional art, there is no need to perform a full scan of the whole active area 805 in display. One or more fingers are locally scanned to facilitate fingerprint recognition. Optionally, one or more fingers are scanned with adapted resolution. For example, in a case of full-display fingerprint recognition, there is a full size image sensor at hand. But the image sensor can be partly activated to scan only area around one or more fingers. The image sensor may adjust its scan resolution on demand, e.g. high resolution for security sensitive scenarios, low resolution for specific APPs, etc.

Such a local finger scan mechanism can provide a high resolution but smaller size image compared to a full display high resolution scan. The final local scan is comparable in size and resolution of the fixed single fingerprint area approach. Such a local scan mechanism scales down the need for the readout circuitry and the associated image processing. It may maintain them to the level of the single fingerprint fixed area approach. In a case of keeping a high resolution sensor array (e.g. 701 in FIG. 7) within the full panel, such mechanism may reduce the overall cost by shrinking the readout circuitry (e.g. 703 in FIG. 7) and/or the image processing part (e.g. 705 in FIG. 7). This is particularly true in the image sensing approach if an organic photodiode matrix is used. And the overall cost of high resolution matrix is weak compared to the readout circuitry if an organic sensor array is used. In other terms, the sensor part cost is weak compared to the readout circuitry part cost in an organic image sensor approach. Furthermore, the power consumption can be improved as well as the processing delay is not substantially impacted.

In FIG. 8b, fingerprint system/function/sensor is powered down while the touch panel is not touched, and the fingerprint system/function/sensor is powered on only when the touch panel is touched. In this case, finger location can be directly given by the touch panel. This allows to deactivate the fingerprint sensor as long as touch panel gives no indication of finger touch to save significant power. As soon as the touch panel detects finger touch, the touch panel controller may detect the finger location and activate the fingerprint sensor to perform local scan around the localized finger. A fingerprint sensor is an electronic device used to capture a digital image of the fingerprint pattern. The captured image is called a live scan. This live scan is digitally processed to create a biometric template (a collection of extracted features) which is stored and used for matching. Many technologies have been used including optical, capacitive, RF, thermal, piezoresistive, ultrasonic, piezoelectric, MEMS. A Wikipedia entry for fingerprint sensor is available at: https://en.wikipedia.org/wiki/Fingerprint_recognition#Fingerprint_sensors, last visited on Apr. 12, 2017.

FIG. 8c illustrates how high resolution local scan are performed around the finger location 803 given by the touch panel. For example, the touch panel is configured to scan active area of the touch sensitive surface with a relatively low resolution in order to detect whether there is at least one finger touching the touch sensitive surface. In a case that at least one finger touching the touch sensitive surface is detected, scanning the touching area (e.g. (X1,Y1), etc.) with a relatively high resolution for fingerprint recognition. A readout circuitry is designated only to the touching area(s). In this case, only a scaled down readout circuitry is equipped to processing fingerprint recognition related to the touching area(s).

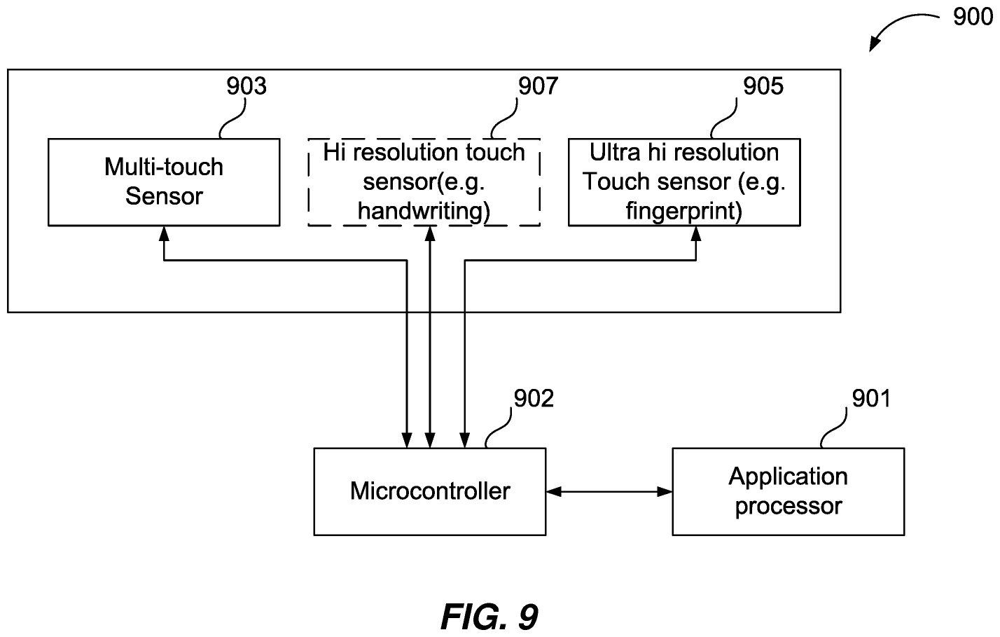

FIG. 9 illustrates an in-display fingerprint recognition enabled electronic device according to an embodiment of the present disclosure. In FIG. 9, touch sensor 903 (may be a multi-touch sensor, e.g. touch sensor 203 in FIG. 2) is configured to detect whether there is finger touch on the touch panel (e.g. touch panel 252 in FIG. 2). In a case that finger touch is detected, fingerprint sensor 905 (e.g. fingerprint recognition sensor 201 in FIG. 2) is activated to perform fingerprint recognition. In a case that fingerprint recognition is completed, or no finger touch is detected, fingerprint sensor 905 is deactivated. The electronic device may include another touch sensor 907 (e.g. pen sensor 254 in FIG. 2). The in-display local scan mechanism for fingerprint recognition may be controlled by microcontroller 902, or together with AP 901. The microcontroller 902 may be integrated into AP 901 (e.g. processor 210 in FIG. 2).

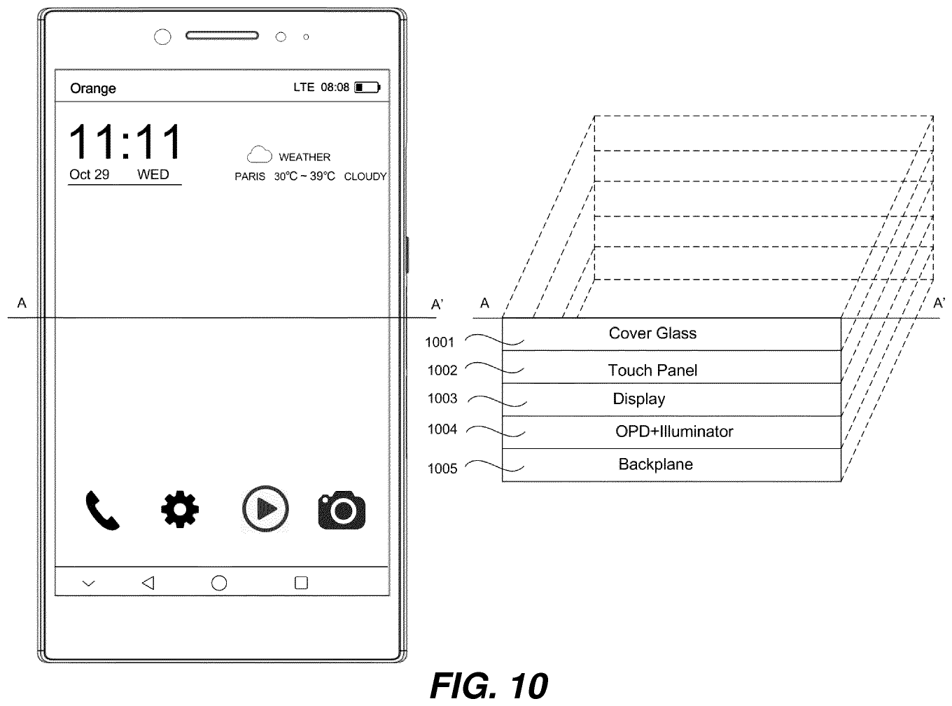

FIG. 10 illustrates an in-display fingerprint recognition enabled electronic device according to an embodiment of the present disclosure. A cover glass 1001 is stacked over a touch sensor/panel 1002. The touch sensor/panel 1002 may be transparent. The touch sensor 1002 is stacked over a display 1003. A fingerprint sensor 1004 is stacked with the display 1003 (over or beneath the display). A backplane 1005 is placed beneath the display. The touch sensor 1002 may include a relatively low resolution sensor working with its associated readout circuitry, and/or controller (e.g. 902 in FIG. 9), etc. The fingerprint sensor 1004 may include a relatively high resolution sensor with its associated readout circuitry, and/or controller (e.g. 902 in FIG. 9), and/or image processing, etc. The relatively high resolution sensor may use an image sensing technology composed by Organic PhotoDiode (OPD) and/or illuminators. The relatively low resolution touch sensor may use the capacitive technology. A touchscreen is an input and output device normally layered on the top of an electronic visual display of an information processing system. A user can give input or control the information processing system through simple or multi-touch gestures by touching the screen with a special stylus and/or one or more fingers. A wikipedia entry for touch screen/touch panel/touch sensitive surface is available at: https://en.wikipedia.org/wiki/Touchscreen, last visited on Mar. 17, 2017. For detailed touch technologies widely used in the industry, reference is made to: “Touch technology in smartphones explained”, http://www.flatpanelshd.com/focus.php?subaction=showfull&id=1348049303, last visited on Mar. 17, 2017; “How it works: The technology of touch screens: From single-touch to multitouch and why all displays are not equal”, http://www.computerworld.com/article/2491831/computer-hardware/computer-hardware-how-it-works-the-technology-of-touch-screens.html, last visited on Mar. 17, 2017. All references are herein incorporated by their entireties.

In a case that the OPD and/or illuminators work in the near-infrared (NIR) region, image sensor can be placed behind the display. In the wavelength, the display remains “transparent” for the image sensor. In another embodiment, the OPD and display can be patterned side by side. In this approach this allows the display to be used as “free” illuminator(s) when working in the visible region as shown in patent application US20150331508, which is herein incorporated by its entirety. A third approach with the fingerprint sensor above the display is also possible. However, transparency of the fingerprint sensor brings a cost of the solution and affects the display performance.

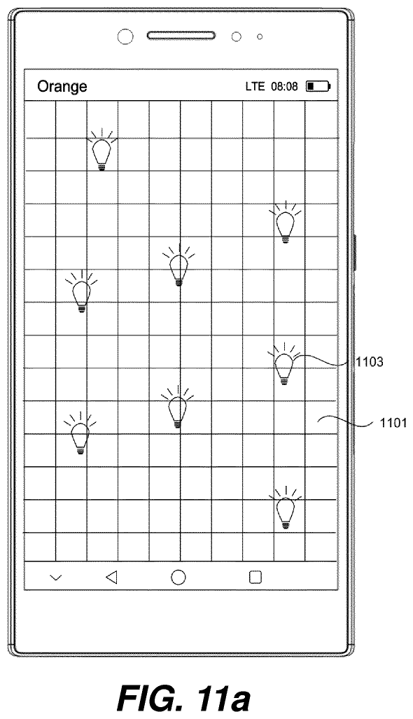

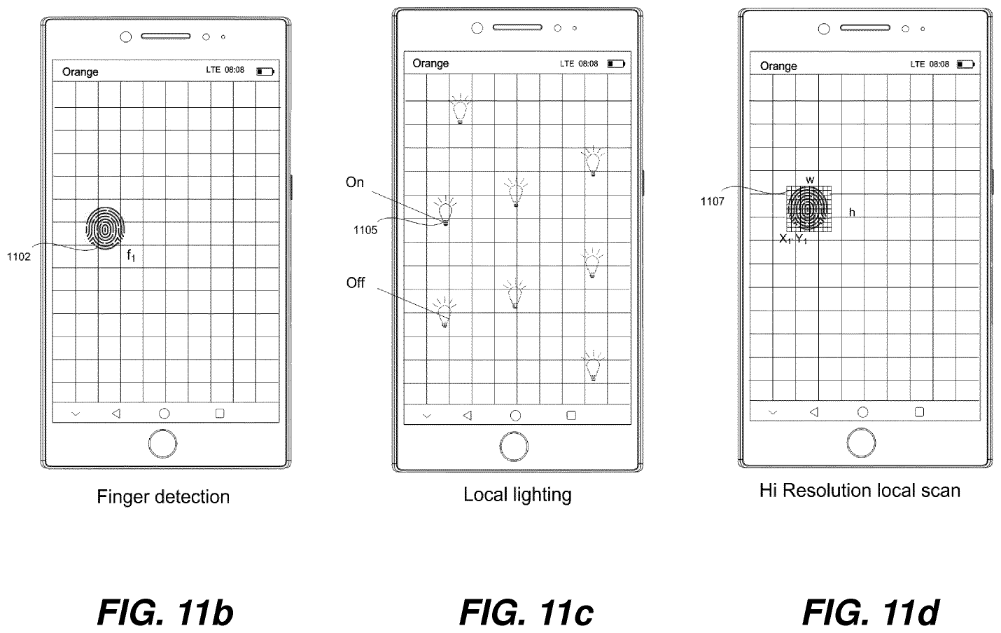

FIGS. 11a-11d illustrates an in-display fingerprint recognition enabled electronic device according to embodiments of the present disclosure. In FIG. 11a, a plurality of illuminators 1103 are used and patterned to cover a full display area 1101. In the image sensor approach, illuminator may be needed to enhance the S/N ratio of the received signal by the photodiode. Illuminator may light the bottom of the finger and the reflected light is received into the photodiodes. Lighting is important in the system. It may also have an impact on the power consumption. As there is a freedom to place the finger on the whole screen, the illuminators may spread over the whole in-display touch area 1101. In an embodiment, finger detection and/or localization is used to control illuminator(s) for providing local lighting on detected finger(s). Such a local lightning solution may improve power consumption of the in-display fingerprint recognition solution. In FIG. 11b, one finger 1102 is detected at f1 location (can be multiple fingers) by a relatively low resolution scan process (e.g. touch sensor). In FIG. 11c, only a subset of illuminators 1105 is activated (can be one illuminator) close to or around/at the detected finger location. In FIG. 11d, a relatively high resolution scan 1107 is performed around the detected finger location with the help of the subset of illuminators 1105. In this way, in-display fingerprint recognition is processed without losing efficiency while saving power. Such a local illuminating and local scanning mechanism also works when the OPD and display are patterned side by side.

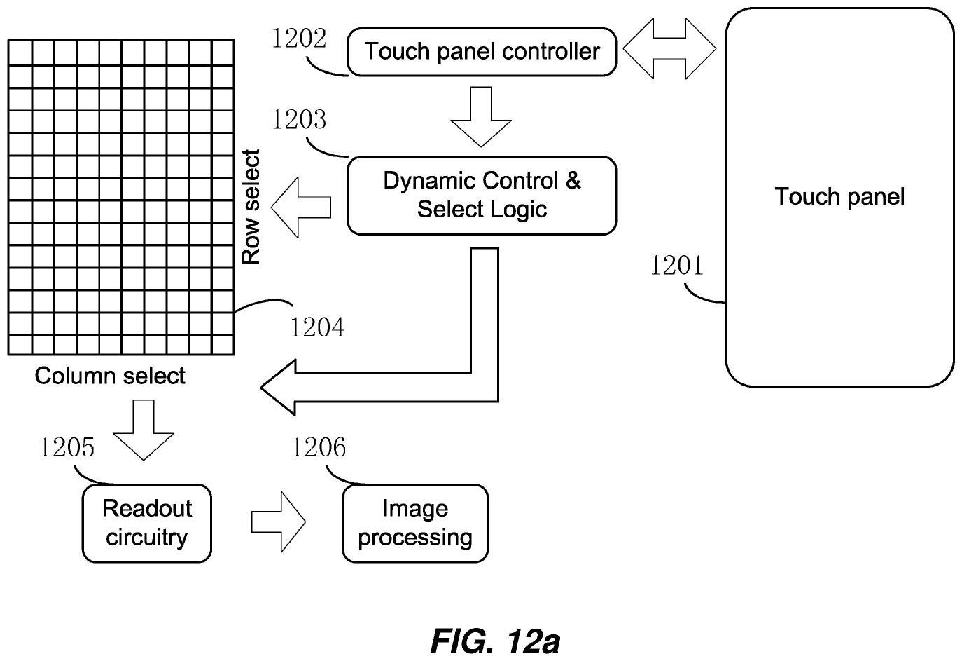

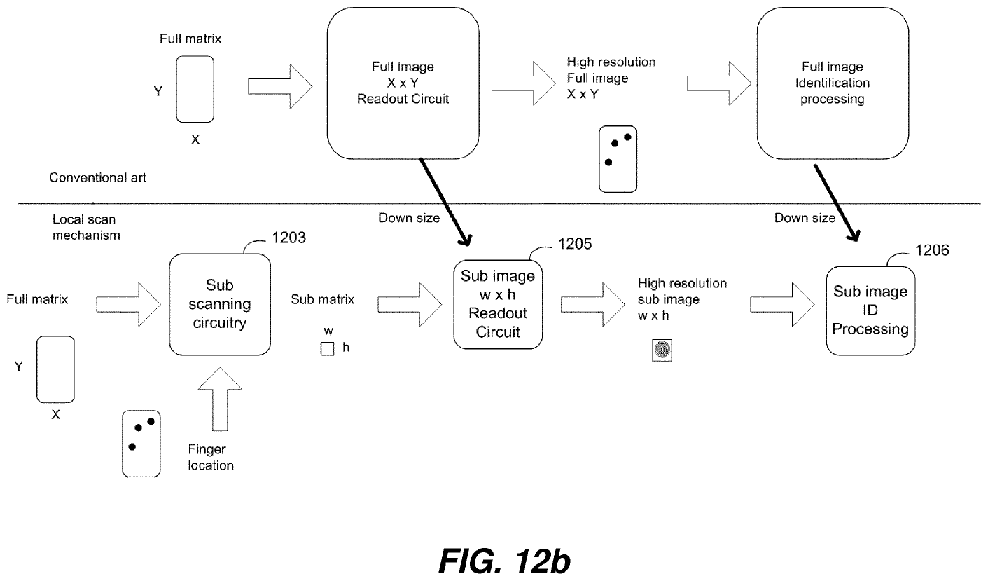

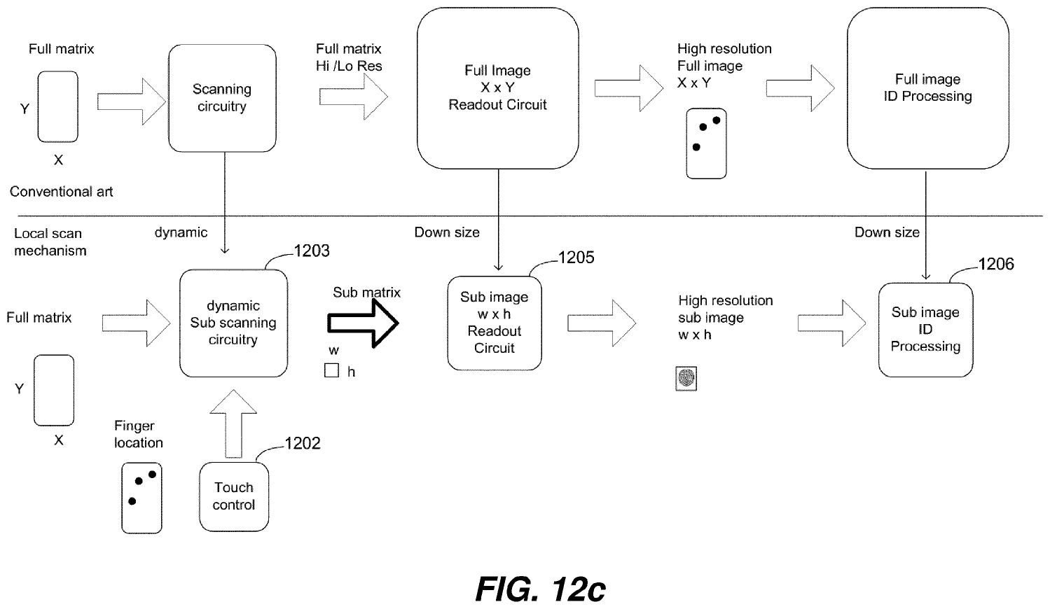

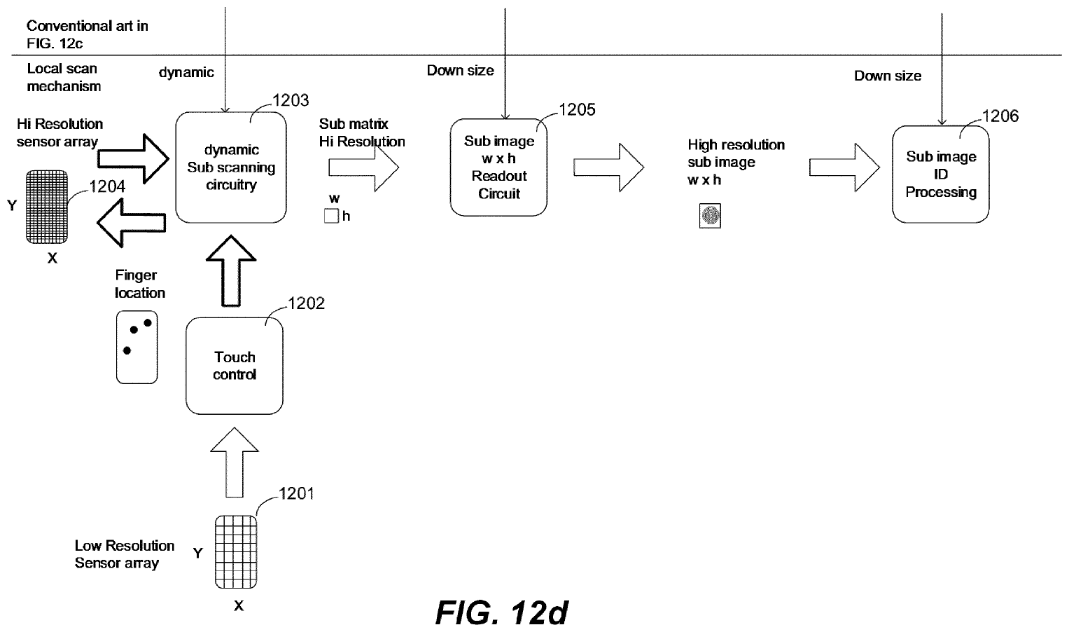

FIG. 12a-12d illustrates an in-display fingerprint recognition enabled electronic device according to embodiments of the present disclosure. In FIG. 12a, the touch panel 1201 is configured to detect finger touch and/or finger location(s). The touch panel may be a capacitive touch panel. It may use a relatively low resolution sensor array with its own scanning and touch detection process managed by a controller 1202 (e.g. 902 in FIG. 9, 210 in FIG. 2). It may output a finger location fi which will be used for fingerprint scan process. For example, a control logic 1203 may be configured to receive the fi location information, and determines a (Xi, Yi, w, h) area to locally scan one or more fingers that touch on the display. This means that only (w×h) pixels are readout from finger location thanks to the control logic 1203, which may be a dynamic programmable scanning circuitry that connects the correct lines and columns from the matrix 1204 (e.g. sensor array 701 in FIG. 7) to the readout circuitry 1205 (e.g. 703 in FIG. 7). The relatively high resolution sub-scanned image may then be passed to the image processing 1206 (e.g. 705 in FIG. 7) for fingerprint recognition. Such a dynamic local scan mechanism proposes a scaled down readout circuitry associated with a downsized image processing compared to conventional art. The readout circuitry and image processing can be dimensioned to process a finger image as it would be in a fixed single fingerprint area approach. The shrinking of relevant circuitry (e.g. readout circuitry, image processing circuitry) allows to reduce overall cost, to improve the power consumption as well as to offer a short delay time response. In short, a local scan mechanism is proposed to dynamically scan image around the finger and ignore the other part of the fingerprint sensor array. In FIG. 12b, it is illustrated how a large X×Y readout circuitry may be replaced by a tinier w×h readout circuitry 1205. And the associated image processing (e.g. memory, processor, algorithm, and database) may be downsized as well. In FIG. 12c, it is illustrated that a dynamic sub-scan circuitry 1203 is configured to deliver a relatively small/scaled down sub matrix (e.g. compared with a full matrix solution) which allows to down size the readout circuitry 1205 and the associated image processing 1206 (e.g. memory, processor, algorithm, database). In FIG. 12d (continue with upper part of FIG. 12c), it is illustrated that the dynamic sub-scan circuitry 1203 control local scan by a relatively high resolution sensor array 1204 with the help of a relatively low resolution sensor array 1201 to detect finger location(s).

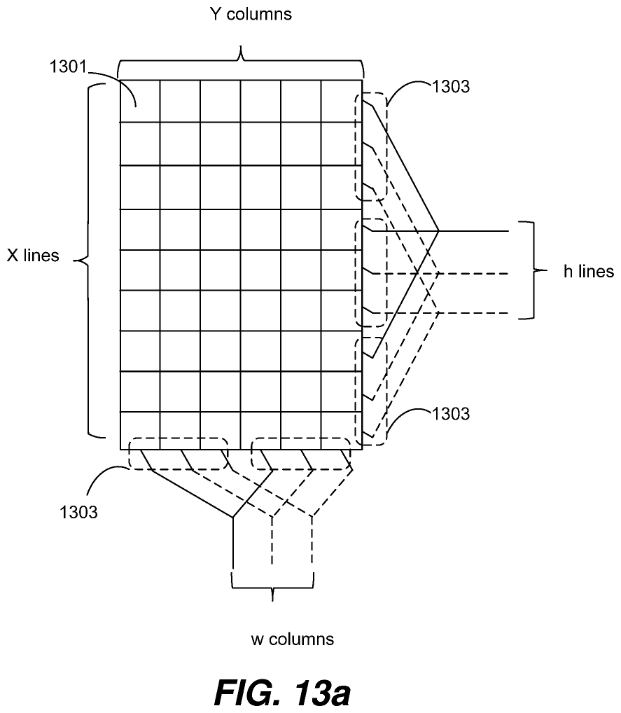

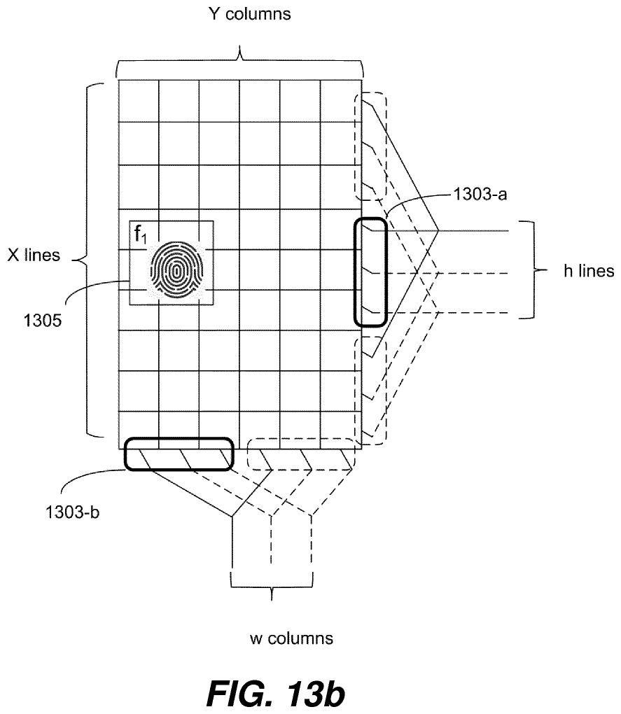

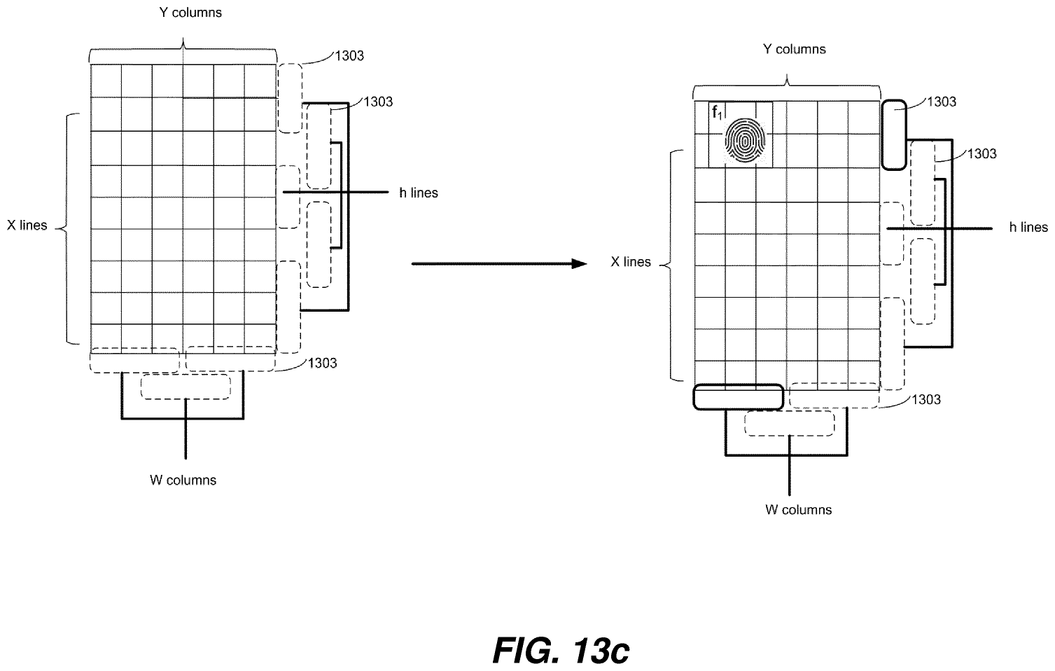

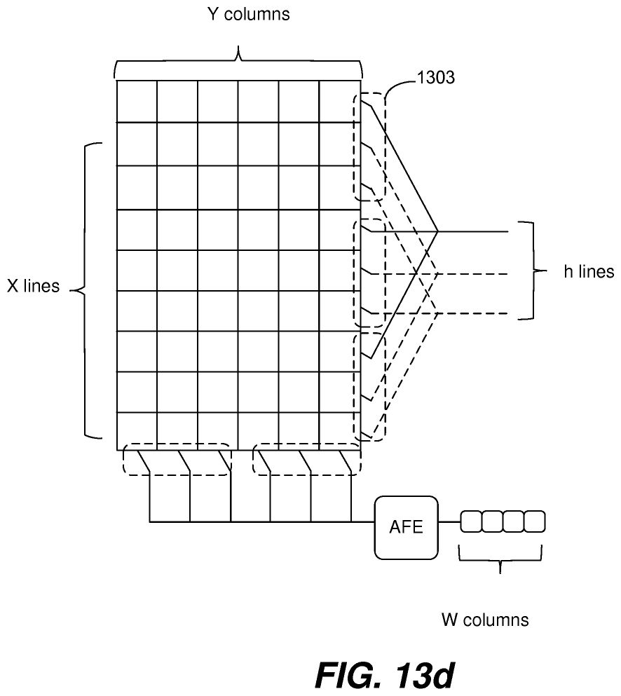

FIGS. 13a-13d illustrate how a large X×Y large sensor array can be shrink into w×h pixels given to the readout circuitry thanks to a selection mechanism, e.g. an array of switches. These switches may be activated according to detected finger location(s). FIG. 13a shows that sensor array 1301 (e.g. sensor array 701) is coupled with a switch array 1303 which may include a plurality of switches/switching transistors. FIG. 13b shows the switches (1303-a, 1303-b, marked in bold) which correspond to/match finger location 1305 (e.g. area around f1) are activated. The mapping of any detected finger location(s) and the group of transistor needed to be switched on is deterministic and evident. Once the mapping is established, the readout process is performed classically by selecting the first row, reading out pixel of the columns and sequentially performing the operation on the next row. A w×h image is then acquired. The structure can take a plurality of architecture. Whatever the architecture, the target is to have an optimized size of the scan bounded around the fingerprint. FIG. 13c shows another example of structure with overlap. FIG. 13d shows another example of structure using “double sequencing”. Double sequence is a sequence of certain elements numbered by two indices. For Double sequence, more detail is referred to Encyclopedia of Mathematics: http://www.encyclopediaofmath.org/index.php?title=Double_sequence&oldid=32337, last visited 12 Apr. 2017. The sequencing is performed on both row and column. While losing acquisition time, it drastically reduces the analog part (then cost and power). This technique is possible as the fingerprint scan does not require fast readout process as classical imaging does. An analog front end (AFE) is coupled to the fingerprint sensing area and is configured to generate an analog response signal. An analog-to-digital converter (ADC) samples the analog response signal and converts the sample to a digital value, which may be received by a digital device such as a processor or CPU. For more application of AFE, reference is made to application US20090252385 A1 and US20170076079 A1, which are herein incorporated with their entireties. A person skilled in the art would appreciate that any combination of aforementioned architecture (or its relevant part) is possible. Moreover, these switching transistors and their associated control (e.g. switch array 1303) based on the finger location can form a “dynamic sub scanning circuitry” (e.g. dynamic control & select logic in FIG. 12a, sub scanning circuitry 1203 in FIGS. 12b-12d) that allows to down size the readout circuitry and the associated image processing (memory, processor, algorithm, database). For more information on using transistor as a switch, reference is made to: “Transistor as a Switch”, http://www.electronics-tutorials.ws/transistor/tran_4.html, last visited Jun. 21, 2017. 2017, which is herein incorporated with its entirety.

The process of local scanning is not limited to one finger. The dynamic sub-scanning can be performed for any finger (s) that has been located within the panel. They can be processed sequentially or in parallel. For example, in a case of multiple fingers substantially simultaneously touching the screen, fingerprint recognition may be performed one finger by one finger in a row according to aforementioned local scan methodology. Resolution on the sub-scanning can also be lowered if needed depending on specific application. One application may not require a full resolution all the time. For example, a low resolution (i.e. 100 ppi) might be sufficient for an application such as: light identification or finger detection.

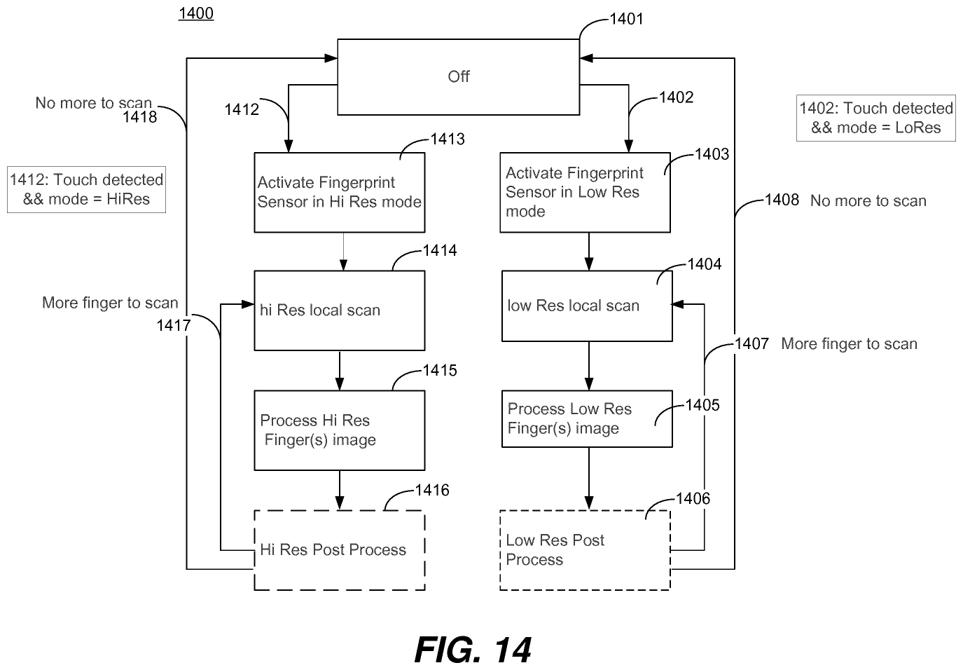

FIG. 14 illustrates a system/methodology/algorithm according to the present disclosure. The system is summarized in the form of a state machine 1400. The fingerprint sensor may be switched between different modes: e.g. Hi Resolution mode (Hi Res mode), Low Resolution mode (Low Res mode), and deactivated. Hi Res mode may be used for scenarios where a high resolution image of a fingerprint is wanted, e.g. fingerprint recognition, and high security identification. Otherwise, Low Res mode may be used, e.g. finger detection and low security identification. In a case that no finger touch is detected, the fingerprint sensor may be deactivated to save power. So the fingerprint sensor is most of the time deactivated and then power is saved. See 1401, fingerprint sensor is off. The fingerprint sensor wakes up only if it is needed (e.g. identification required, or finger type/location detection needed). See 1402/1412, touch detected. See 1403/1413, fingerprint sensor is activated. The fingerprint sensor and its associated circuitry is activated and then dynamic sub scan/local scan and relevant processing is performed as long as it is needed (e.g. multi-finger touches, finger tracking, etc.). See 1404/1414, local scan. See 1405/1415, image processing. Output(s) from fingerprint recognition processing may be given to application(s) that can act accordingly (e.g. wake up display after identification, tool changing upon finger type detection, change mode etc.) See 1406/1416, optional post process. From the state machine 1400, a person skilled in the art would appreciate that the fingerprint sensor can be dynamically activated/deactivated, and local scan can be dynamically performed.

While a particular feature or aspect of the disclosure may have been disclosed with respect to only one of several implementations or embodiments, such feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

1. An electronic device, comprising:
a touch sensitive surface comprising a first area, wherein the first area comprises a second area, and wherein the second area is smaller than the first area;
a touch sensing arrangement coupled to the first area, wherein the second area is determined based on a first output from the touch sensing arrangement;
a fingerprint recognition arrangement coupled to the second area, wherein the fingerprint recognition arrangement comprises readout circuitry covering the second area; and
a plurality of illuminators coupled to the touch sensitive surface and corresponding to the first area.

2. (canceled)

3. The electronic device of claim 1, wherein the fingerprint recognition arrangement further comprises scanning circuitry coupled to the readout circuitry and corresponding to the second area.

4. The electronic device of claim 3, wherein the readout circuitry is configured to:
receive a sub-matrix from the scanning circuitry; and
output a sub image based on the sub-matrix to an image processing resource.

5. The electronic device of claim 3, wherein the scanning circuitry is configured to activate a plurality of switches based on a second output from the touch sensing arrangement to obtain activated switches, and wherein the activated switches correspond to the second area.

6. (canceled)

7. The electronic device of claim 1, wherein at least one illuminator is configured to activate based on a third output from the touch sensing arrangement.

8. The electronic device of claim 1, wherein the fingerprint recognition arrangement further comprises an image processing resource coupled to the readout circuitry and configured to:
receive an input from the readout circuitry; and
perform fingerprint recognition processing based on the input.

9. A method of processing fingerprint recognition for an electronic device with a touch sensitive surface, comprising:
detecting, by a touch sensing arrangement, at least one finger touching the touch sensitive surface, wherein the touch sensing arrangement associated with a first area within the touch sensitive surface;
scanning, by a fingerprint recognition arrangement, a second area within the first area for fingerprint recognition of the at least one finger, wherein the second area is determined based on a first output from the touch sensing arrangement, wherein the fingerprint recognition arrangement comprises readout circuitry covering the second area, and wherein the second area is smaller than the first area; and
activating at least one illuminator from a plurality of illuminators based on a second output from the touch sensing arrangement, wherein the illuminators correspond to the first area.

10.-11. (canceled)

12. The method of claim 9, further comprising activating a plurality of switches based on a third output from the touch sensing arrangement to obtain activated switches, wherein the activated switches correspond to the second area.

13.-15. (canceled)

16. The method of claim 9, wherein the at least one illuminator is located in the second area.

17. The method of claim 9, wherein the at least one illuminator is located proximate to the second area.

18. The method of claim 9, wherein the fingerprint recognition arrangement comprises scanning circuitry corresponding to the second area.

19. The method of claim 18, further comprising:
receiving, by the readout circuitry, a sub-matrix from the scanning circuitry; and
outputting, by the readout circuitry, a sub image based on the sub-matrix to an image processing resource.

20. A computer program product comprising computer-executable instructions for storage on a non-transitory computer-readable storage medium that, when executed by a processor, cause an apparatus to:
detect, using a touch sensing arrangement, at least one finger touching a touch sensitive surface, wherein the touch sensing arrangement is associated with a first area within the touch sensitive surface;
scan, using a fingerprint recognition arrangement, a second area within the first area for fingerprint recognition of the at least one finger, wherein the second area is determined based on a first output from the touch sensing arrangement, wherein the fingerprint recognition arrangement comprises readout circuitry covering the second area, and wherein the second area is smaller than the first area; and
activate at least one illuminator from a plurality of illuminators based on a second output from the touch sensing arrangement, wherein the illuminators correspond to the first area.

21. The computer program product of claim 20, wherein the at least one illuminator is located in the second area.

22. The computer program product of claim 20, wherein the at least one illuminator is located proximate to the second area.

23. The computer program product of claim 20, wherein the computer-executable instructions further cause the apparatus to activate a plurality of switches based on a third output from the touch sensing arrangement to obtain activated switches, and wherein the activated switches correspond to the second area.

24. The computer program product of claim 20, wherein the fingerprint recognition arrangement comprises scanning circuitry corresponding to the second area.

25. The computer program product of claim 24, wherein the computer-executable instructions further cause the apparatus to:
receive, by the readout circuitry, a sub-matrix from the scanning circuitry; and
output, by the readout circuitry, a sub image based on the sub-matrix to an image processing resource.

26. The electronic device of claim 7, wherein the at least one illuminator is located in the second area.

27. The electronic device of claim 7, wherein the at least one illuminator is located proximate to the second area.
